(19) United States
(12) Patent Application Publication
(10) Pub. No.: US 2010/0072738 A1
(43) Pub. Date: Mar. 25, 2010

(54) Steering System

(75) Inventors: William A. Szabela, Brookston, IN (US); James R. Johnson, Lafayette, IN (US); Kenneth A. Sherwin, West Lafayette, IN (US)

Correspondence Address: TAROLLI, SUNDHEIM, COVELL & TUMMINO L.L.P., 1300 EAST NINTH STREET, SUITE 1700, CLEVEVLAND, OH, 44114, US

(73) Assignee: TRW Automotive U.S. LLC

(21) Appl. No.: 12/284,184

(22) Filed: Sep. 19, 2008

(51) Int. Cl. B62D 5/04

(52) U.S. Cl. 280/771

(57) ABSTRACT

Steerable vehicle wheels (12,14) are turned under the influence of force transmitted through a steering column (22). A closed loop assembly (32) is connected with the steering column (22). The closed loop assembly (22) includes a first motor (52) which is connected with a first gear unit (56). The first gear unit (56) is operated in response to the output from a first sensor (48). A feedback sensor (66) is connected with the steering column (22) adjacent to an output from the first gear unit (56). An open loop assembly (34) is connected with the steering column (22) and includes a second motor (88) which is connected with a second gear unit (92). The second motor (88) is operated in response to the output from a second sensor (82). A manual steering gear (20) is operated to turn the steerable vehicle wheels (12,14) under the influence of force transmitted from the steering wheel (18), first motor (52) and second motor (88) through the steering column (22).

### TECHNICAL FIELD

The present invention relates to a steering apparatus for turning the steerable wheels on a vehicle in response to rotation of a vehicle steering wheel.

### BACKGROUND OF THE INVENTION

Vehicle power steering systems have commonly included a hydraulic motor which is supplied with fluid (oil) from a reservoir by a pump. The pump is driven by an engine of a vehicle. Steering systems having this known construction have been utilized in heavy duty vehicles, such as trucks.

### SUMMARY OF THE INVENTION

The present invention provides a new and improved apparatus for use in turning steerable vehicle wheels under the influence of force transmitted through a steering column. The steering column extends between a steering wheel and a steering gear which is connected with steerable vehicle wheels. Since the force for operating the steering gear is transmitted through the steering column, a separate pump and hydraulic motor does not have to be provided in association with the steering gear to effect operation of the steering gear.

The apparatus for turning the steerable vehicle wheels includes first and second motors which are connected with the steering column at locations disposed between a steering wheel and the steering gear. A closed loop assembly may be connected with the steering column. In addition, an open loop assembly may be connected with the steering column.

The closed loop assembly includes a first control unit and the first motor. The first control unit is connected with a first sensor which is disposed at a location between the steering wheel and a first gear unit. The first sensor provides an output to the first control unit as a function of torque applied to and rotation of the steering wheel. A feedback sensor is connected with a first control unit and the steering column adjacent to an output from the first gear unit.

The open loop assembly includes a second control unit and the second motor. The second control unit is connected with a second sensor. The second sensor is connected with the steering column at a location between the first gear unit and a second gear unit.

### BRIEF DESCRIPTION OF THE DRAWINGS

The foregoing and other features of the present invention will become apparent to those skilled in the art to which the present invention relates upon reading the following description with reference to the accompanying drawings in which:

FIG. 1 is a schematic illustration of a vehicle steering apparatus constructed in accordance with the present invention to turn steerable vehicle wheels.

### DESCRIPTION OF ONE EMBODIMENT OF THE INVENTION

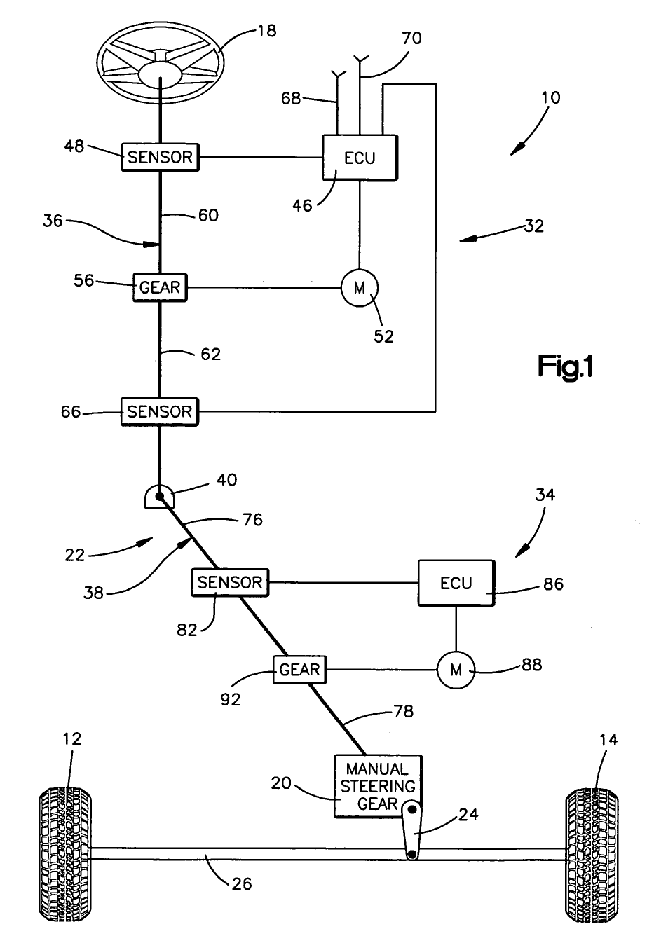

An apparatus 10 (FIG. 1) is provided to turn steerable vehicle wheels 12 and 14. The apparatus 10 includes a steering wheel 18 which is rotated by an operator of the vehicle. The steering wheel 18 is connected with a manually actuated steering gear 20 by a steering column 22.

Upon rotation of the steering wheel 18, force is transmitted through the steering column 22 to the manually actuated steering gear 20. This force effects operation of the manually actuated steering gear 20. Upon operation of the manually actuated steering gear 20, an output member 24 from the steering gear effects turning movement of the steerable vehicle wheels 12 and 14 through a known linkage 26.

The manually actuated steering gear 20 is operated under the influence of force transmitted to the manually actuated steering gear through the steering column 22. The manually actuated steering gear 20 does not contain a source of force or power, such as a hydraulic motor and/or electric motor. All of the force which is transmitted from the manually actuated steering gear 20 to the linkage 26 and steerable vehicle wheels 12 and 14 is transmitted to the manually actuated steering gear through the steering column 22.

It is contemplated that the apparatus 10 will advantageously be associated with a heavy duty vehicle, such as a truck. Therefore, the manually actuated steering gear 20 must be capable of transmitting relatively large forces from the steering column 22 to the linkage 26 and steerable vehicle wheels 12 and 14.

To enable relatively large forces to be transmitted from the manually actuated steering gear 20 to the steerable vehicle wheels 12 and 14, it is contemplated that the manually actuated steering gear 20 will be constructed with a steering gear ratio of approximately twenty-eight to one (28:1). This results in an input member to the manually actuated steering gear 20 rotating through twenty-eight (28) revolutions for each revolution of the output member 24. Of course, the manually actuated steering gear 20 may be constructed with a gear ratio which is different than this specific gear ratio.

In the embodiment of the invention illustrated in FIG. 1, the manually actuated steering gear 20 is of the type which includes a worm and sector gear. The worm is connected with an input to the manually actuated steering gear 20. The sector gear engages the worm and is connected to the output member 24. Of course the manually actuated steering gear 20 may have a different construction if desired. For example, the manually actuated steering gear 20 may be of the rack and pinion type.

The apparatus 10 includes a closed loop assembly 32 which is connected with the steering column 22 at a location adjacent to the steering wheel 18. In addition, the apparatus 10 includes an open loop assembly 34. The open loop assembly 34 is connected with the steering column 22 at a location between the manually actuated steering gear 20 and the location where the closed loop assembly 32 is connected with the steering column 22.

In the embodiment of the invention illustrated in FIG. 1, the steering column 22 includes an upper link 36 which is connected with the steering wheel 18. A lower link 38 is connected with the upper link 36 and the manually actuated steering gear 20. In the illustrated embodiment of the invention, a universal joint 40 interconnects the upper and lower links 36 and 38. If desired, telescopically extendable and retractable slip joints (not shown) may be provided in association with the upper and/or lower links 36 and/or 38.

Although the closed loop assembly 32 is connected with the upper link 36 and the open loop assembly 34 is connected with the lower link 38, it is contemplated that the closed loop assembly and open loop assembly may both be connected with a single link in the steering column 22. If desired, the steering column 22 may contain either a greater or lesser number of links.

The closed loop assembly 32 is a control system which automatically acts to maintain a desired output through the steering column 22 in response to rotation of the steering wheel 18. The closed loop assembly includes an electronic control unit (ECU) 46 which is connected with a sensor 48. The sensor 48 has an output which is a function of torque applied to the steering wheel 18 and angular rotation of the steering wheel.

The control unit 46 effects operation of a reversible electric motor 52 as a function of the output from the sensor 48. The electric motor 52 is connected with a gear assembly 56. The gear assembly 56 is a differential gear assembly having a known construction.

A rigid upper portion 60 of the upper link 36 is connected to an input of the gear assembly 56. A rigid lower portion 62 of the upper link 36 is connected with an output from the gear assembly 56. The reversible electric motor 52 is connected to and drives a second input to the gear assembly 56.

The gear assembly 56 may have a construction which is different from the construction of a differential gear assembly. For example, the gear assembly 56 may include a first spur gear which is connected with the upper and lower portions 60 and 62 of the upper link 36. A second spur gear, which is driven by the motor 52, may be disposed in meshing engagement with the first spur gear.

The motor 52 may be operated to cause the gear assembly 56 to assist the operator in rotating the steering wheel 18. The motor 52 may also be operated to resist rotation of the steering wheel 18 to provide ‘feel” to the operator rotating the steering wheel. The control unit 46 effects operation of the motor 52 to either assist or resist steering wheel rotation as a function of vehicle operating conditions.

A feedback sensor 66 is connected with the lower portion 62 of the upper link 36 and with the output from the gear assembly 56. The feedback sensor provides an output to the control unit 46 as a function of angular rotation of the lower portion 62 of the upper link 36. The control unit 46 is operable to effect operation of the reversible electric motor 52 as a function of both the output from the first or upper sensor 48 and the feedback sensor 66. Additional inputs may be provided to the control unit 46 over conductors 68 and 70. The inputs to the control unit 46 over the conductors 68 and 70 may be a function of vehicle speed, lateral acceleration, and/or other operating conditions associated with the vehicles in which the apparatus 10 is disposed.

The open loop assembly 34 uses only the torque and rotational input to a rigid upper portion 76 of the lower link 38 to control an input to a rigid lower portion 78 of the lower link 38. The open loop control assembly 34 does not sense torque and rotation of the lower portion 78 of the lower link 38. The lower portion 78 of the lower link 38 is connected to an input member of the manually actuated steering gear 20.

The open loop assembly 34 includes an input sensor 82 which senses torque and rotation transmitted from the gear assembly 56. The input sensor 82 is connected with a control unit (ECU) 86. The control unit 86 controls operation of a second or lower reversible electric motor 88. The lower motor 88 is connected to the input of a gear assembly 92.

The illustrated gear assembly 92 is a differential gear assembly having an input connected to the upper portion 76 of the lower link 38. The differential gear assembly 92 also has an input connected to the lower reversible electric motor 88. The output from the gear assembly 92 is connected to the lower portion 78 of the lower link 38.

Although the gear assembly 92 is a differential gear assembly having a known construction, it is contemplated that the gear assembly 92 may have a different construction if desired. For example, the gear assembly 92 may be formed by a first spur gear which is connected with the upper and lower portions 76 and 78 of the lower link 38. The reversible electric motor 88 may be connected with the first spur gear by a second spur gear which is disposed in meshing engagement with the first spur gear.

The closed loop assembly 32 is responsive to changes in input torque to the steering wheel 18 and to changes in the rate of rotation of the steering wheel. The open loop assembly 34 senses and modifies the rate of rotation and torque applied to the lower link 38 in the steering column 22. In the event of a malfunctioning of the closed loop assembly 32, the open loop assembly 34 is operable in response to changes in the input torque to and rate of rotation of the steering wheel 18. Since the apparatus 10 includes both the closed loop assembly 32 and open loop assembly 34 redundancy is provided in the control system.

Having described the invention, the following is claimed:

1. An apparatus for use in turning steerable vehicle wheels, said apparatus comprising
a steering column connected with a vehicle steering wheel;
a manual steering gear connected with the steerable vehicle wheels and said steering column, said manual steering gear being operable under the influence of force transmitted through said steering column to turn the steerable vehicle wheels;
a first gear unit connected with said steering column;
a first motor connected with said first gear unit and operable to transmit force through said first gear unit to said steering column;
a second gear unit connected with said steering column at a location between said manual steering gear and said first gear unit; and
a second motor connected with said second gear unit and operable to transmit force through said second gear unit to said steering column.

2. An apparatus as set forth in claim 1 further including a first sensor connected with said steering column at a location between said first gear unit and the steering wheel, a first control unit connected with said first sensor and said first motor, said first sensor provides an output to said first control unit as a function of torque applied to the steering wheel.

3. An apparatus as set forth in claim 2 further including a feedback sensor connected with said steering column at a location between said first and second gear units, said feedback sensor being connected with said first control unit and providing an output to said first control unit as a function of an output from said first gear unit to a portion of said steering column disposed between said first and second gear units.

4. An apparatus as set forth in claim 3 further including a second sensor connected with the steering column at a location between said first gear unit and said second gear unit, a second control unit connected with said second sensor and said second motor, said second sensor providing an output to said second control unit as a function of an output from said first gear unit to a portion of said steering column disposed between said first and second gear units.

5. An apparatus as set forth in claim 4 wherein said second control unit effects operation of said second motor independently of a portion of the steering column connected to the output of said second gear unit.

6. An apparatus as set forth in claim 1 wherein said manual steering gear has an input member which rotates through approximately 28 revolutions for each revolution of an output member of the manual steering gear.

7. An apparatus as set forth in claim 1 wherein the steerable vehicle wheels are turned only under the influence of force applied to the steering wheel and force provided by the first and second motors.

8. An apparatus for use in turning steerable vehicle wheels under the influence of force transmitted through a steering column which extends between a steering wheel and a steering gear connected with the steerable vehicle wheels, said apparatus comprising:
a closed loop assembly connected with the steering column, said closed loop assembly including a first gear unit connected with the steering column, a first sensor connected with the steering linkage at a location between the steering wheel and said first gear unit, a first control unit connected with said first sensor, said first sensor providing an output to said first control unit as a function of torque applied to and rotation of the steering wheel, a first motor connected with said first gear unit and said first control unit, and a feedback sensor connected with said first control unit and the steering column adjacent an output of said first gear unit, said feedback sensor providing an output to said first control unit as a function of rotation of a portion of the steering column connected to the output of said first gear unit, said first control unit being operable to effect operation of said first motor as a function of the outputs from said first sensor and said feedback sensor; and
an open loop assembly connected with the steering column at a location between said first gear unit and the steering gear, said open loop assembly including a second gear unit connected with the steering column, a second sensor connected with the steering column at a location between the first and second gear units, a second control unit connected with the second sensor, said second sensor providing an output to said second control unit as a function of torque transmitted from and rotation of an output from said first gear unit, a second motor connected with said second gear unit and said second control unit, said second control unit being operable to effect operation of said second motor as a function of the output from said second sensor.

9. An apparatus as set forth in claim 8 wherein said second control unit effects operation of said second motor independently of rotation of a portion of the steering column connected to the output of said second gear unit.

10. An apparatus as set forth in claim 8 the steering gear has an input member which rotates through approximately 28 revolutions for each revolution of an output member of the steering gear.

11. An apparatus as set forth in claim 8 wherein wherein the steerable vehicle wheels are turned under only the influence of force applied to the steering wheel and force provided by the first and second motors.
